(19) United States
(12) Patent Application Publication
(10) Pub. No.: US 2007/0165327 A1
(43) Pub. Date: Jul. 19, 2007

(54) APPARATUS TO FIX A DISK AND A METHOD THEREOF

(76) Inventors: Min-pyo HONG, Suwon-si (KR); Yong-kyu BYUN, Yongin-si (KR); Cheol-soon KIM, Anyang-sil (KR); No-yeol PARK, Seongnam (KR)

Correspondence Address: STANZIONE & KIM, LLP, 919 18TH STREET, N.W., SUITE 440, WASHINGTON, DC, 20006, US

(21) Appl. No.: 11/617,102

(22) Filed: Dec. 28, 2006

(30) Foreign Application Priority Data
Dec. 28, 2005 (KR) 2005-131883

(51) Int. Cl. G11B 17/02

(52) U.S. Cl. 360/99.12

(57) ABSTRACT

A disk fixing apparatus to fix a disk onto a spindle motor in a hard disk drive (HDD). The apparatus includes a coupling hole, in which a coupling portion to fix the disk fixing apparatus onto the spindle motor is inserted, on a center portion of the disk fixing apparatus, and an attaching portion, to which the disk is attached on an outer portion of the disk fixing apparatus. The attaching portion includes an attaching surface extending in a vertical direction so that a part of an inner circumferential surface of the disk can be attached to the attaching surface and/or an attaching surface facing an upper surface or a lower surface of the disk and extending in a horizontal direction so that a part of a non-recording region on the upper surface or the lower surface of the disk can be attached to the attaching surface. Thus, the stress applied to the disk can be reduced and the deformation of the disk can be reduced, and thus, changes in floating height of the head slider can be minimized. Therefore, the recording and reproducing performances of the magnetic head can be improved, and the recording density of the disk can increase.

### CROSS-REFERENCE TO RELATED APPLICATIONS

This application claims the priority under 35 U.S.C. 119 §(a) of Korean Patent Application No. 10-2005-0131883, filed on Dec. 28, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive (HDD), and more particularly, to an apparatus to fix a disk that is a data storage medium, onto a spindle motor that is a driving unit, and a method thereof.

2. Description of the Related Art

Hard disk drives (HDDs) are auxiliary memory devices installed in a host system, such as a computer, to record new data onto a disk that is a data recording medium, or to reproduce data stored in the disk using a magnetic head.

FIG. 1 is a cross-sectional view illustrating a conventional disk clamp.

Referring to FIG. 1, the conventional disk clamp 10 includes a screw coupling hole 11 formed on a center portion thereof, a pressing portion 12 disposed on an outer portion, and two through eight tooling holes 13 disposed with predetermined intervals therebetween along a circumferential direction of the disk clamp 10 in order to prevent a spindle motor from rotating when a screw 5 is coupled to the disk clamp 10. In addition, the disk clamp 10 is formed of a material that can be elastically deformed. In order to assemble the disk clamp 10, an inner diameter hole 2 of a disk 1 is placed onto a motor hub 3 that is a rotator of the spindle motor, then the disk clamp 10 is covered, and then the screw 5 is turned. The screw 5 penetrates the screw coupling hole 11 and is inserted into the hub 3 of the spindle motor. Thus, the disk clamp 10 is fixed on the motor hub 3, and the pressing portion 12 presses the disk 1 to fix the disk 1 onto the motor hub 3. The pressing force of the pressing portion 12 is caused by an elastic force of the disk clamp 10 generated when the screw 5 is turned. However, when the screw 5 is turned, stress generated on a surface of the disk 1, to which the disk clamp 10 contacts, is not even along the circumferential direction because the stress is concentrated around the tooling holes 13. Thus, inconsistent disk deformation occurs due to the uneven stress.

The inconsistent disk deformation changes a floating height of the magnetic head from the disk 1, that is, the magnetic recording medium, and thus, it may be difficult to record the data in desired bits, or the recording may fail. In addition, constant magnetic signals may not be obtained when reproducing the data from the disk 1. Furthermore, the disk 1 may collide with the magnetic head, which results in a permanent damage of the magnetic head and the disk 1. In particular, as the size of the HDD is reduced, the above problem becomes more severe.

According to the disk clamping method using the elastic force of the disk clamp 10, uneven stress is applied to the disk 1 due to a contacting tolerance of the pressing portion 12 that is inevitably generated when fabricating the disk clamp 10, and thus, the disk 1 may be deformed unevenly.

In addition, it is difficult to guide assembling positions accurately during assembly of the disk clamp 10, and thus, the disk 1 vibrates due to uneven rotational mass generated by a mismatch between centers of the disk 1 and the rotary shaft of the spindle motor. Therefore, repeatable run-out performance is degraded, and there is a limitation in how much a track width of the data recorded into the disk 1 may be reduced.

### SUMMARY OF THE INVENTION

The present general inventive concept provides a disk fixing apparatus having a structure, an outer portion of which is attached to a disk and an inner portion of which is coupled to a hub of a spindle motor using a screw, in order not to use an elastic force when the disk is fixed.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a disk fixing apparatus to fix a disk on a spindle motor in a hard disk drive (HDD), the apparatus including a coupling hole on a center portion of the disk fixing apparatus, in which a coupling portion to fix the disk fixing apparatus onto the spindle motor is inserted, and an attaching portion, on an outer portion of the disk fixing apparatus, to which the disk is attached.

The attaching portion may further include an attaching surface to extend in a vertical direction so that a part of an inner circumferential surface of the disk can be attached to the attaching surface.

The attaching portion may further include an attaching surface to face an upper surface or a lower surface of the disk, and to extend in a horizontal direction so that a part of a non-recording region on the upper surface or the lower surface of the disk can be attached to the attaching surface.

The attaching portion may further include a first attaching surface to extend in a vertical direction, so that a part of the inner circumferential surface of the disk can be attached to the first attaching surface, and a second attaching surface to face the upper surface or the lower surface of the disk and to extend in a horizontal direction so that a part of the non-recording region on the upper surface or the lower surface of the disk can be attached to the second attaching surface.

A coupling surface may be formed around the coupling hole so that a center of contact pressure applied onto the upper surface of the disk fixing apparatus, which contacts the coupling portion to be pressed, can substantially match with a center of contact pressure applied onto the lower surface of the disk fixing apparatus, which contacts an upper portion of the spindle motor hub to be pressed, when the disk fixing apparatus is fixed onto the spindle motor using the coupling portion.

The disk fixing apparatus may be formed of stainless steel or aluminum. However, other materials that perform the intended operations of the present general inventive concept may be used alternatively.

A protruding portion inserted into the coupling hole of the disk fixing apparatus may be formed on the spindle motor hub, and an inner diameter of the coupling hole may be 5 μm ˜10 μm larger than an outer diameter of the protruding portion.

The disk fixing apparatus may further include a disk, in which information is recorded, and a groove may be formed on an inner portion of the non-recording region of the disk that is located on an outer portion of the attaching portion of the disk along a circumferential direction of the disk.

A surface of the attaching portion, which is attached to the disk, may be etched.

The attaching portion may include a recess to increase the area attaching to the disk.

The disk fixing apparatus may further include a disk, in which information is recorded, which may be attached to the disk fixing apparatus using an adhesive which is an ultraviolet (UV) curing resin. The adhesive may be an epoxy-based adhesive.

The foregoing and/or other aspects and utilities of the present general inventive concept may also be achieved by providing a disk fixing apparatus to fix a disk on a spindle motor in an HDD, the apparatus include, a disk, in which information is recorded, having a groove formed along a circumference of the disk on a non-recording region that is disposed on an inner circumferential side of the disk, a coupling hole, in which a coupling portion to fix the disk fixing apparatus onto the spindle motor is inserted, on a center portion of the disk fixing apparatus, and an attaching portion including a first attaching surface extending in a vertical direction so that a part of an inner circumferential surface of the disk can be attached to the first attaching surface, and a second attaching surface facing an upper surface or a lower surface of the disk and extending in a horizontal direction so that a part of the non-recording region on the upper surface or the lower surface of the disk can be attached to the second attaching surface.

The foregoing and/or other aspects and utilities of the present general inventive concept may also be achieved by providing a disk fixing apparatus to fix a disk on a spindle motor in a hard disk drive (HDD), the apparatus including a disk-shaped body, a coupling portion at a center portion of the disk-shaped body to fix the disk fixing apparatus onto the spindle motor, and an adhering portion at an outer portion of the disk-shaped body to adhere an inner portion of the disk thereto.

The outer portion of the disk-shaped body may adhere to an inner circumferential portion of the disk.

The outer portion of the disk-shaped body may adhere to a non-writable surface of the disk.

The adhering portion is an epoxy-based adhesive.

The inner circumferential portion of the disk includes a top portion and a side portion of the inner circumference of the disk.

The inner circumferential portion of the disk includes a bottom portion and a side portion of the inner circumference of the disk.

The foregoing and/or other aspects and utilities of the present general inventive concept may also be achieved by providing a method of fixing a disk to a hard disk drive (HDD), the method including fastening a disk fixing apparatus to a spindle motor of the HDD, and adhering an outer portion of the disk fixing apparatus to an inner portion of the disk.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view illustrating a disk clamp according to the conventional art;

FIG. 2 is a cross-sectional view illustrating a disk fixing apparatus assembled onto a hub of a spindle motor according to an embodiment of the present general inventive concept;

FIGS. 3A and 3B are a plan view and a front view, respectively, illustrating the disk fixing apparatus according to the embodiment of FIG. 2;

FIG. 4 is a cross-sectional view illustrating a coupling portion of the disk fixing apparatus assembled onto the spindle motor hub using a screw illustrated in FIG. 2;

FIG. 5 is a cross-sectional view illustrating a disk fixing apparatus assembled onto a hub of a spindle motor according to another embodiment of the present general inventive concept;

FIG. 6 is a cross-sectional view illustrating a disk fixing apparatus assembled onto a hub of a spindle motor according to another embodiment of the present general inventive concept;

FIG. 7 is a cross-sectional view illustrating a disk fixing apparatus assembled onto a hub of a spindle motor according to another embodiment of the present general inventive concept;

FIG. 8 is an exploded perspective view illustrating processes of assembling the disk fixing apparatus onto the hub of the spindle motor according to the embodiments of FIGS. 2 and 5-7;

FIG. 9 is a three-dimensional view illustrating a deformed status of a disk that is fixed by the conventional disk clamp of FIG. 1; and

FIG. 10 is a three-dimensional view illustrating a deformed status of a disk that is fixed by the disk fixing apparatus of FIG. 2 according to the embodiment of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

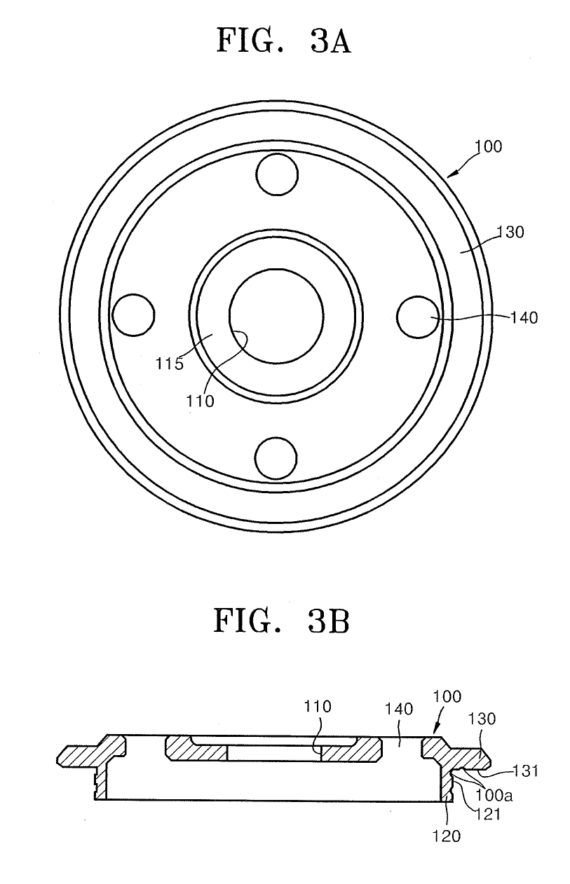

FIG. 2 is a cross-sectional view illustrating a disk fixing apparatus assembled onto a hub of a spindle motor according to an embodiment of the present general inventive concept, and FIGS. 3A and 3B are a plan view and a front view, respectively of the disk fixing apparatus of FIG. 2.

Referring to FIGS. 2, 3A, and 3B, a disk fixing apparatus 100 according to the present embodiment includes a coupling hole 110 on a center portion thereof, and a coupling portion 115 having an upper coupling surface 115a and a lower coupling surface 115b around the coupling hole 110. Avertical attaching portion 120, having a vertical attaching surface 121 that extends in a vertical direction so as to be attached to at least a part of an inner circumferential surface 51 of a disk 50, is disposed on an outer portion of the disk fixing apparatus 100. In addition, a horizontal attaching portion 130, having a horizontal attaching surface 131 that faces an upper surface 52 of the disk 50 and extends in a horizontal direction so as to be attached to at least a part of a non-recording region on the upper surface 52 of the disk 50, is disposed on the outer portion of the disk fixing apparatus 100.

In more detail, a corner of the inner circumference of the disk 50 may be attached to the disk fixing apparatus 100, or the inner circumferential surface 51 of the disk 50, including the corner, may be attached to the disk fixing apparatus 100. In addition, at least a part of the non-recording region on the upper surface 52 of the disk 50 may be attached to the disk fixing apparatus 100. A lower corner of the vertical attaching portion 120 of the disk fixing apparatus 100 may be attached to the inner circumferential surface 51 of the disk 50. Otherwise, an outer corner of the horizontal attaching portion 130 may be attached to the upper surface 52 of the disk 50.

The disk 50 is coupled to the disk fixing apparatus 100 using an adhesive 400 while mounting the disk 50 onto the vertical and horizontal attaching surfaces 121 and 131 of the vertical and horizontal attaching portions 120 and 130 in the disk fixing apparatus 100. In addition, the screw 200 is coupled to the spindle motor hub 300 of the spindle motor through the coupling hole 110. Then, the disk fixing apparatus 100 is fixed on the spindle motor hub 300. The adhesive 400 used to attach the disk 50 onto the disk fixing apparatus 100 may be an ultra-violet (UV) curing resin, for example, an epoxy-based adhesive. The epoxy-based adhesive can be easily obtained, for example, Anaerobic UV Curing Adhesive, product No. AS-5503 (AS-550LVUV-J) manufactured by ASEC Co., LTD, Japan.

To increase an attaching strength between the disk fixing apparatus 100 and the disk 50, the vertical and horizontal attaching surfaces 121 and 131 of the disk fixing apparatus 100, which are attached to the disk 50, may be etched to have rough surfaces. In addition, recesses 100a may be formed on the vertical and horizontal attaching surfaces 121 and 131 to increase the area attaching to the disk 50. Here, in order to prevent the disk 50 from being deformed by a bonding stress, a stress shielding groove 54 may be formed on an outer portion of the attaching region along a circumference of the non-recording area of the disk 50.

The disk fixing apparatus 100 can be formed of a material having a thermal expansion coefficient that is similar to the disk 50 in order to minimize the thermal deformation in high temperature and low temperature environments. For example, if the substrate of the disk 50 is formed of a glass, the disk fixing apparatus 100 may be formed of a stainless steel. If the substrate of the disk 50 is formed of aluminum (Al), the disk fixing apparatus 100 may be formed of the aluminum. Additionally, four tooling holes 140 may be formed on the disk fixing apparatus 100 with predetermined intervals therebetween along the circumference of the disk fixing apparatus 100.

A protruding portion 310 inserted into the coupling hole 110 of the disk fixing apparatus 100 may be formed on an upper end of the spindle motor hub 300. In addition, to center the disk fixing apparatus 100, an inner diameter of the coupling hole 110 is 5 μm ˜10 μm larger than an outer diameter of the protruding portion 310.

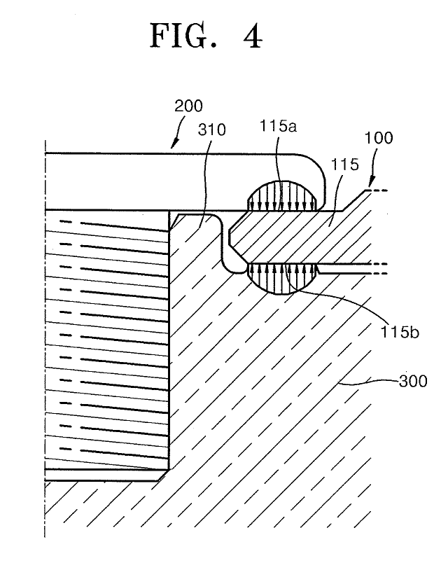

FIG. 4 is a cross-sectional view illustrating the coupling portion of the disk fixing apparatus 100 assembled onto the spindle motor hub of FIG. 2 using a screw.

Referring to FIG. 4, when the coupling portion 115 of the disk fixing apparatus 100 is fixed using the screw 200, a momentary stress may occur due to a variation between centers of contact pressures applied to an upper coupling surface 115a and to a lower coupling surface 115b of the coupling portion 115. The momentary stress causes a deformation of the disk fixing apparatus 100, and thus, contacting areas of the upper and lower coupling surfaces 115a and 115b should be optimized so that the centers of the contacting pressures applied onto the surfaces 115a and 115b coincide with each other.

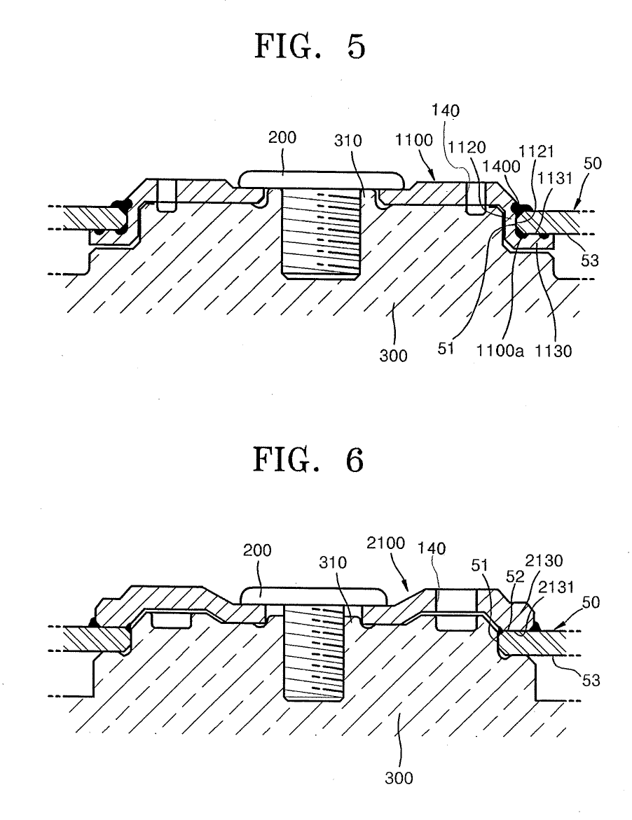

FIG. 5 is a cross-sectional view illustrating a disk fixing apparatus assembled onto a spindle motor hub according to another embodiment of the present general inventive concept. The disk fixing apparatus of FIG. 5 includes an attaching portion that is different from that of the disk fixing apparatus of FIG. 2.

Referring to FIG. 5, a vertical attaching portion 1120, having a vertical attaching surface 1121 that extends in a vertical direction so as to attach to at least a part of the inner circumferential surface 51 of the disk 50, is disposed on an outer portion of the disk fixing apparatus 1100. In addition, a horizontal attaching portion 1130 having a horizontal attaching surface 1131 that faces the lower surface 53 of the disk 50 and extends in a horizontal direction so as to attach to at least a part of the lower surface 53 of the disk 50 is disposed on the outer portion of the disk fixing apparatus 1100.

In more detail, a corner of the inner circumference of the disk 50 may be attached to the disk fixing apparatus 1100, or the inner circumferential surface 51 of the disk 50 including the inner circumferential corner may be attached to the disk fixing apparatus 1100. In addition, at least a part of the lower surface 53 of the disk 50 may be attached to the disk fixing apparatus 1100. Otherwise, an outer corner of the horizontal attaching portion 1130 of the disk fixing apparatus 1100 may be attached to the lower surface 53 of the disk 50.

Similar to the embodiment of FIG. 2, the disk SO is attached to the disk fixing apparatus 1100 using an adhesive 1400 applied between the disk 50 and the disk fixing apparatus 1100. In addition, recesses 1100a may be formed on the vertical and horizontal attaching surfaces 1121 and 1131 of the disk fixing apparatus 1100 in order to increase the area attaching to the disk 50.

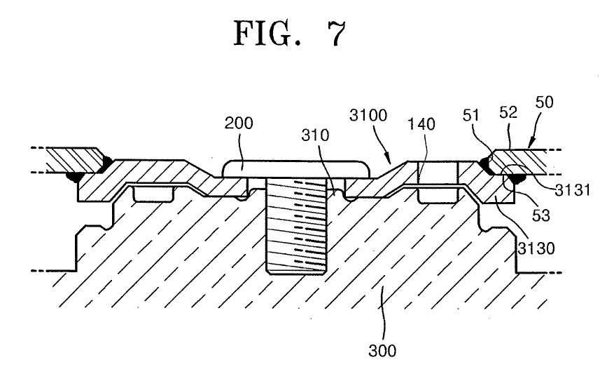

FIG. 6 is a cross-sectional view illustrating a disk fixing apparatus assembled onto a spindle motor hub according to another embodiment of the present general inventive concept.

Referring to FIG. 6, a horizontal attaching portion 2130, having a horizontal attaching surface 2131 that faces the upper surface 52 of the disk 50 and extends in a horizontal direction so as to attach to at least a part of the non-recording region on the upper surface 52 of the disk 50, is disposed on an outer portion of the disk fixing apparatus 2100.

In more detail, at least a part of the upper surface 52 of the disk 50 may be attached to the disk fixing apparatus 2100. In addition, an inner circumferential comer of the upper surface 52 of the disk 50 may be attached to the disk fixing apparatus 2100. Otherwise, an outer corner of the horizontal attaching portion 2130 of the disk fixing apparatus 2100 may be attached to the upper surface 52 of the disk 50.

FIG. 7 is a cross-sectional view illustrating a disk fixing apparatus assembled onto a spindle motor hub according to another embodiment of the present general inventive concept.

Referring to FIG. 7, a horizontal attaching portion 3130, having a horizontal attaching surface 3131 that faces the lower surface 53 of the disk 50 and extends in a horizontal direction so as to attach to at least a part of the lower surface 53 of the disk 50, is disposed on an outer portion of the disk fixing apparatus 3100.

In more detail, a part of the lower surface 53 of the disk 50 can be attached to the disk fixing apparatus 3100. In addition, an outer corner of the horizontal attaching portion 3130 of the disk fixing apparatus 3100 can be attached to the lower surface 53 of the disk 50.

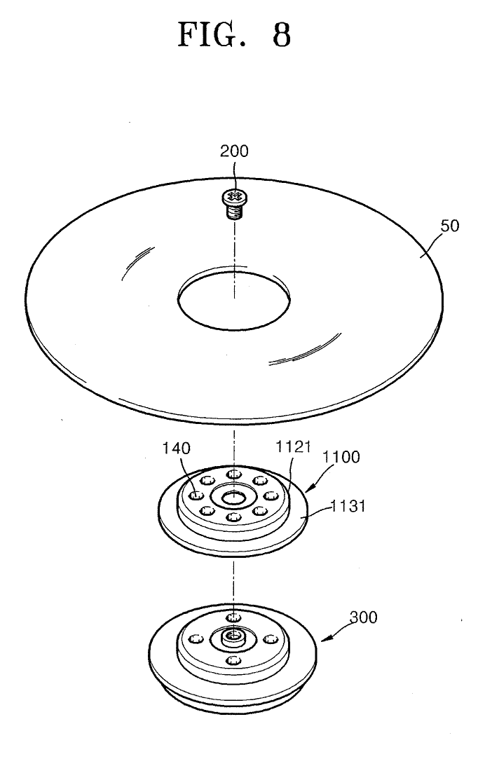

FIG. 8 is an exploded perspective view illustrating processes of assembling the disk fixing apparatus on the spindle motor hub according to the embodiments of FIGS. 2 and 5-7. The disk fixing apparatus of FIG. 5 is referenced as an example.

Referring to FIG. 8, the disk fixing apparatus 1100 is prepared first. The disk fixing apparatus 1100 can be fabricated using a pressing method or a machining method.

Next, the disk 50 is mounted onto the attaching surfaces 1121 and 1131 of the disk fixing apparatus 1100. The disk fixing apparatus according to the embodiments of FIGS. 5 and 7 may be turned over so that the attaching surface can face upward.

Then, the disk 50 and the disk fixing apparatus 1100 are centered, and the disk 50 is fixed onto the disk fixing apparatus 1100 using an adhesive. The adhesive may be AS-5503(AS-550LVUV-J) that is one of Anaerobic UV Curing Adhesive products manufactured by ASEC Co., LTD, Japan.

Next, the coupled body of the disk 50 and the disk fixing apparatus 1100 are mounted on the spindle motor hub 300.

Then, the coupled body of the disk 50 and the disk fixing apparatus 1100 are fixed on the spindle motor hub 300 using the screw 200. At this time, a jig may be inserted into the tooling hole 140 of the disk fixing apparatus 1100 to fix the spindle motor hub 300 and to prevent the spindle motor hub 300 from rotating idly.

As described above, the disk fixing apparatus fixes the disk using an attaching method without using an elastic force, and thus, the assembly operation can be performed more easily and precisely than the conventional disk fixing apparatus that fixes the disk using the elastic force.

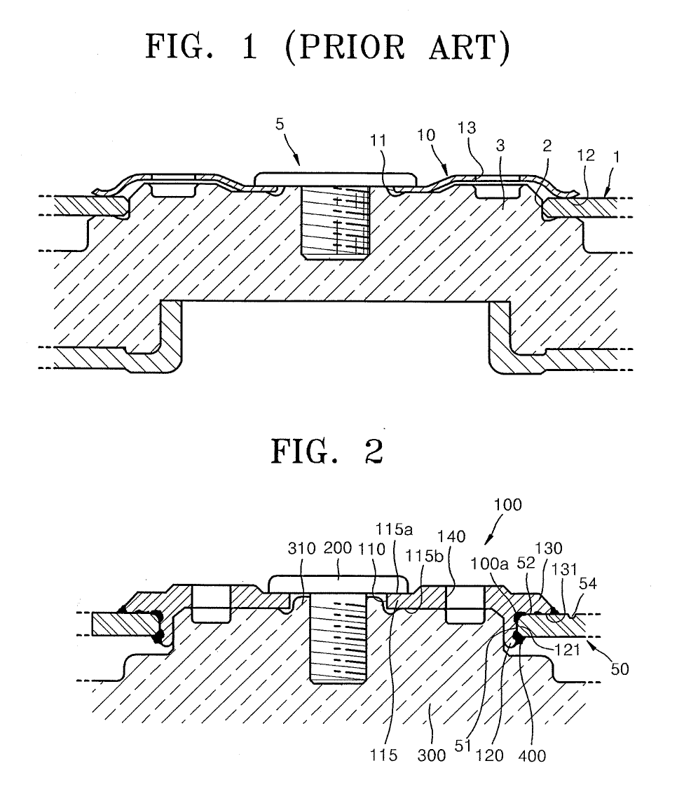

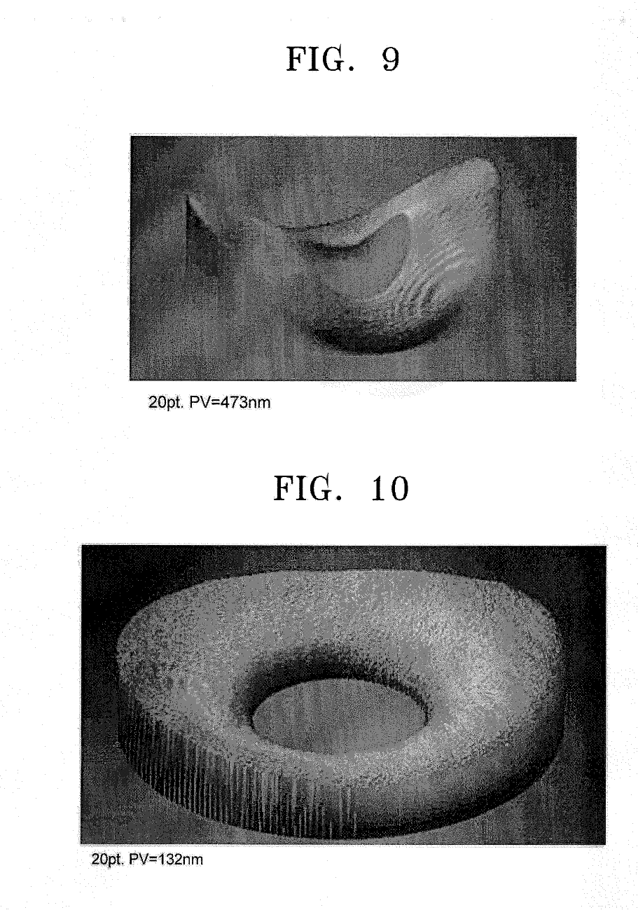

FIG. 9 is a three-dimensional view illustrating a deformed status of the disk that is fixed by the conventional disk clamp of FIG. 1, and FIG. 10 is a three-dimensional view illustrating a deformed status of the disk that is fixed by the disk fixing apparatus of FIG. 2 according to the present general inventive concept.

FIGS. 9 and 10 are three-dimensional graphs respectively illustrating the deformed states of the disks of the conventional art and of the present general inventive concept, and the deformed states are measured at 20 points on each of the disks. The conventional disk clamp is the disk clamp of FIG. 1 having eight tooling holes, and the disk fixing apparatus of the present general inventive concept is the disk fixing apparatus of FIG. 2. The disk is formed of stainless steel, the thickness of the disk is 0.381 mm, and the outer diameter of the disk is 21.6 mm.

As illustrated in FIG. 9, when the disk is fixed onto the spindle motor using the conventional disk clamp, the deformation value PV (Peak to Valley: the value obtained by subtracting the lowest point from the highest point of deformation) is 473 nm. When considering the floating height of the head slider, that is, about 8 nm ˜12 nm in an HDD having a small size of 1 inch or smaller, the deformation of the disk according to the conventional art adversely affects the floating performance of the head slider, and thus, the head slider may contact the disk.

In contrast, referring to FIG. 10, the deformation value PV of the disk is 132 nm at most according to the embodiment of FIG. 2 of the present general inventive concept. The deformation occurs evenly, and the deformation value is about ⅓ of the conventional deformation value. Thus, the deformation can be controlled sufficiently in the small size HDD of 1 inch or less, the deformation occurs evenly, and the head slider can float stably.

According to the disk fixing apparatus of the various embodiments of the present general inventive concept, the stress applied to the disk can be reduced and the deformation of the disk can be reduced, and thus, changes in floating height of the head slider can be minimized. Therefore, the recording and reproducing performances of the magnetic head can be improved, and the recording density of the disk can increase.

In addition, since the disk can be fixed firmly on the disk fixing apparatus according to the present general inventive concept, slipping phenomenon of the disk can be reduced and a data track density of the disk can increase.

Also, an aligning error generated when the disk is assembled on the spindle motor hub can be minimized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A disk fixing apparatus to fix a disk on a spindle motor in a hard disk drive (HDD), the apparatus comprising:
a coupling hole, in which a coupling portion to fix the disk fixing apparatus onto the spindle motor is inserted, on a center portion of the disk fixing apparatus; and
an attaching portion, to which the disk is attached, on an outer portion of the disk fixing apparatus.

2. The disk fixing apparatus of claim 1, wherein the attaching portion includes an attaching surface to extend in a vertical direction so that a part of an inner circumferential surface of the disk can be attached to the attaching surface.

3. The disk fixing apparatus of claim 1, wherein the attaching portion includes an attaching surface facing an upper surface or a lower surface of the disk to extend in a horizontal direction so that a part of a non-recording region on the upper surface or the lower surface of the disk can be attached to the attaching surface.

4. The disk fixing apparatus of claim 1, wherein the attaching portion includes a first attaching surface to extend in a vertical direction so that a part of the inner circumferential surface of the disk can be attached to the first attaching surface, and a second attaching surface to face the upper surface or the lower surface of the disk and to extend in a horizontal direction so that a part of the non-recording region on the upper surface or the lower surface of the disk can be attached to the second attaching surface.

5. The disk fixing apparatus of claim 1, wherein a coupling surface is formed around the coupling hole so that a center of contact pressure applied onto the upper surface of the disk fixing apparatus, which contacts the coupling portion to be pressed, substantially matches a center of contact pressure applied onto the lower surface of the disk fixing apparatus, which contacts an upper portion of the spindle motor hub to be pressed, when the disk fixing apparatus is fixed onto the spindle motor using the coupling portion.

6. The disk fixing apparatus of claim 1, wherein the disk fixing apparatus comprises stainless steel or aluminum.

7. The disk fixing apparatus of claim 1, further comprising:
a protruding portion formed on the spindle motor hub, and inserted into the coupling hole of the disk fixing apparatus; and
an inner diameter of the coupling hole being 5 μm ˜10 μm larger than an outer diameter of the protruding portion.

8. The disk fixing apparatus of claim 1, further comprising:
a disk in which information is recorded; and
a groove formed on an inner portion of the non-recording region of the disk that is located on an outer portion of the attaching portion of the disk along a circumferential direction of the disk.

9. The disk fixing apparatus of claim 1, wherein a surface of the attaching portion, which is attached to the disk, is etched.

10. The disk fixing apparatus of claim 1, wherein the attaching portion includes a recess to increase the area attaching to the disk.

11. The disk fixing apparatus of claim 1, further comprising:
a disk in which information is recorded; and
an adhesive which is an ultraviolet (UV) curing resin to attach the disk to the disk fixing apparatus.

12. The disk fixing apparatus of claim 11, wherein the adhesive is an epoxy-based adhesive.

13. A disk fixing apparatus to fix a disk on a spindle motor in an HDD, the apparatus comprising:
a disk in which information is recorded, having a groove formed along a circumference of the disk on a non-recording region that is disposed on an inner circumferential side of the disk;
a coupling hole in which a coupling portion to fix the disk fixing apparatus onto the spindle motor is inserted, on a center portion of the disk fixing apparatus; and
an attaching portion including a first attaching surface extending in a vertical direction so that a part of an inner circumferential surface of the disk can be attached to the first attaching surface, and a second attaching surface facing an upper surface or a lower surface of the disk and extending in a horizontal direction so that a part of the non-recording region on the upper surface or the lower surface of the disk can be attached to the second attaching surface.

14. A disk fixing apparatus to fix a disk on a spindle motor in a hard disk drive (HDD), the apparatus comprising:
a disk-shaped body;
a coupling portion at a center portion of the disk-shaped body to fix the disk fixing apparatus onto the spindle motor; and
an adhering portion at an outer portion of the disk-shaped body to adhere an inner portion of the disk thereto.

15. The disk fixing apparatus of claim 14, wherein the outer portion of the disk-shaped body adheres to an inner circumferential portion of the disk.

16. The disk fixing apparatus of claim 14, wherein the outer portion of the disk-shaped body adheres to a non-writable surface of the disk.

17. The disk fixing apparatus of claim 14, wherein the adhering portion is an epoxy-based adhesive.

18. The disk fixing apparatus of claim 16, wherein the inner circumferential portion of the disk includes a top portion and a side portion of the inner circumference of the disk.

19. The disk fixing apparatus of claim 16, wherein the inner circumferential portion of the disk includes a bottom portion and a side portion of the inner circumference of the disk.

20. A method of fixing a disk to a hard disk drive (HDD), the method comprising:
fastening a disk fixing apparatus to a spindle motor of the HDD; and
adhering an outer portion of the disk fixing apparatus to an inner portion of the disk.
